(19) United States
(12) Patent Application Publication
(10) Pub. No.: US 2008/0148995 A1
(43) Pub. Date: Jun. 26, 2008

(54) TINTING SCHEME

(75) Inventors: Aimee Lawlor, Medina, OH (US); Renee Entinghe, Avon, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: THE GLIDDEN COMPANY, Strongsville, OH (US)

(21) Appl. No.: 11/868,263

(22) Filed: Oct. 5, 2007

Related U.S. Application Data
(60) Provisional application No. 60/861,823, filed on Nov. 30, 2006.

(51) Int. Cl. C04B 16/00

(52) U.S. Cl. 106/499

(57) ABSTRACT

A tinting scheme for making low volatile organic solvent-containing waterborne paints is provided, the tinting scheme comprising: a plurality of tinting dosage units, each tinting dosage unit comprising a predetermined quantity of a water dispersible particulate tinter comprising a pigment or mixture of pigments in a water soluble envelope; one or more base paints whose volatile organic solvents content is less than about 150 g/l; such that in use the one or more tinting dosage units is added to the one or more base paints to produce a tinted paint whose volatile organic solvents content is less than about 150 g/l. Paint compositions and methods of tinting waterborne paints are also disclosed.

### RELATED U.S. APPLICATION DATA

This application claims the benefit of priority from U.S. Provisional Application No. 60/861,823 filed on Nov. 30, 2006. The entire disclosure of the earlier application is hereby incorporated by reference.

### BACKGROUND

Coating compositions, for example, paints, lacquers, varnishes, and wood stains for use in decorating buildings, their fixtures and fittings, are supplied as either ready mixed products, where color is added at the point of manufacture, or as tinted products, where color is added at the point of purchase or even at the point of use.

Generally speaking, the range of ready mixed colors that can be made available is limited because available in-store display space is limited. Tinting, and particularly, in-store tinting, allows a wide range of colors to be made available in-store as less display space is required. The availability of a wide range of colors is particularly important to professional painters and decorators and increasingly to a number of consumers who are more adventurous about interior decoration or who wish to personalise their homes.

Tinting is normally carried out in-store using a computer-controlled tinting machine. The process comprises adding to a base paint, one or more pigment-containing tinters according to a recipe to produce a particular predetermined color. Tinters generally comprise a dispersion of a single pigment in an aqueous medium. The base paint can be a standard white paint or one or more base paints particularly formulated for tinting.

In-store tinting as described is a complex process requiring high capital value equipment and often the employing of trained operators. Hence, it can be out of reach for small or medium-sized stores. In addition, it is becoming increasingly important to provide tinted paint with low to zero volatile organic solvent contents.

### SUMMARY

In one embodiment, a tinting scheme for making low volatile organic solvent-containing waterborne paints is provided, the tinting scheme comprising: a plurality of tinting dosage units, each tinting dosage unit comprising a predetermined quantity of a water dispersible particulate tinter comprising a pigment or mixture of pigments in a water soluble envelope; one or more base paints whose volatile organic solvents content is less than about 150 g/l; such that in use the one or more tinting dosage units is added to the one or more base paints to produce a tinted paint whose volatile organic solvents content is less than about 150 g/l.

In another embodiment, a paint composition is provided, the paint composition comprising: a waterborne base paint having a volatile organic solvents content of less than about 150 g/l; a water dispersible particulate tinter, the water dispersible particulate tinter being derived from one or more tinting dosage units, each tinting dosage unit comprising a water soluble envelope, wherein the water dispersible particulate tinter comprises one or more pigments, and wherein the water dispersible particulate tinter has a volatile organic solvents content of less than about 5%; wherein the paint composition has a volatile organic solvents content of less than about 150 g/l.

In yet another embodiment, a method of tinting a waterborne paint is provided, the method comprising: providing one or more tinting dosage units comprising a water dispersible particulate tinter, the water dispersible particulate tinter having a volatile organic solvents content of less than about 5%; providing one or more base paints having a volatile organic solvents content of less than about 150 g/l; and mixing the one or mole tinting dosage units with the one or more base paints to produce a tinted, waterborne paint having a volatile organic solvents content of less than about 150 g/l.

### BRIEF DESCRIPTION OF THE DRAWINGS

The accompanying figures, which are incorporated in and constitute a part of the specification, illustrate various example systems, methods, results and so on, and are used merely to illustrate various example embodiments.

FIG. 1 illustrates an exemplary moisture resistant package, schematically depicted as surrounding a pouch.

FIG. 2 illustrates a cross-sectional view of an exemplary moisture resistant package having a plurality of pouches.

FIG. 3 illustrates a kit having a plurality of moisture resistant packages.

FIG. 4 illustrates an exemplary grouping of a range of shades of color achievable by the present embodiments.

FIG. 5 illustrates an exemplary range of color in a system of pouches.

FIG. 6 illustrates a schematic representation of an exemplary process for producing a particulate dry tinter.

### DETAILED DESCRIPTION

The present embodiments disclose, among other things, a tinting scheme for making low volatile organic solvent-containing waterborne paints. The tinting scheme comprises: a plurality of tinting dosage units, each tinting dosage unit comprising a predetermined quantity of a water dispersible particulate tinter comprising a pigment or mixture of pigments in a water soluble envelope; one or more base paints whose volatile organic solvents content is less than about 150 g/l; such that in use the one or more tinting dosage units is added to the one or more base paints to produce a tinted paint whose volatile organic solvents content is less than about 150 g/l.

Water dispersible particulate tinters are comprised of particulate pigments and additives that facilitate dispersion in aqueous media. The water dispersible particulate tinters' average particle size may be in the range of about 50 to about 5000 μm. The average particle size may also be from about 100 to about 1000 μm. The BET surface area of the pigment granules may be ≦about 15 m²/g, and may be ≦about 10 m²/g.

These pigments may be organic or inorganic. The particulate tinters may comprise one or more organic or inorganic pigments or mixtures of organic and inorganic pigments. Some pigments are in the form of fine powders with an average particle size of from about 0.1 to about 5 μm, inclusive. Such pigments can be formulated with additives to produce particulate tinters of larger particle size.

The pigments, whether organic or inorganic, may be achromatic (i.e., black or white) or colored (i.e., have a color other than black or white). Inorganic pigments also include luster pigments.

Examples of suitable inorganic pigments may include titanium dioxide, optionally surface treated, zirconium and cerium oxides, as well as zinc, (black, yellow or red) iron or chromium oxides, manganese violet, ultramarine blue, chromium hydrate and ferric blue, and metal powders, such as aluminium powder and copper powder. Examples of suitable organic pigments may include carbon black, pigments of D & C type and lakes based on cochineal carmine and on barium, strontium, calcium or aluminium.

Further examples of suitable organic and inorganic color pigments may include: monoazo pigments: C.I. Pigment Brown 25; C.I. Pigment Orange 5, 13, 36, 38, 64 and 67; C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4, 63, 112, 146, 148, 170, 175, 184, 185, 187, 191:1, 208, 210, 245, 247 and 251; C.I. Pigment Yellow 1, 3, 62, 65, 73, 74, 97, 120, 151, 154, 168, 181, 183 and 191; C.I. Pigment Violet 32; disazo pigments: C.I. Pigment Orange 16, 34, 44 and 72; C.I. Pigment Yellow 12, 13, 14, 16, 17, 81, 83, 106, 113, 126, 127, 155, 174, 176 and 188; disazo condensation C.I. Pigment Yellow 93, 95 and 128; pigments: C.I. Pigment Red 144, 166, 214, 220, 221, 242 and 262; C.I. Pigment Brown 23 and 41; anthanthrone pigments: C.I. Pigment Red 168; anthraquinone pigments: C.I. Pigment Yellow 147, 177 and 199; C.I. Pigment Violet 31; anthrapyrimidine; pigments: C.I. Pigment Yellow 108; quinacridone pigments: C.I. Pigment Orange 48 and 49; C.I. Pigment Red 122, 202, 206 and 209; C.I. Pigment Violet 19; quinophthalone pigments: C.I. Pigment Yellow 138; diketopyrrolopyrrole pigments: C.I. Pigment Orange 71, 73 and 81; C.I. Pigment Red 254, 255, 264, 270 and 272; dioxazine pigments: C.I. Pigment Violet 23 and 37; C.I. Pigment Blue 80; flavanthrone pigments: C.I. Pigment Yellow 24; indanthrone pigments: C.I. Pigment Blue 60 and 64; isoindoline pigments: C.I. Pigments Orange 61 and 69; C.I. Pigment Red 260; C.I. Pigment Yellow 139 and 185; isoindolinone pigments. C.I. Pigment Yellow 109, 110 and 173; isoviolanthrone pigments. C.I. Pigment Violet 31; metal complex pigments: C.I. Pigment Red 257; I C.I. Pigment Yellow 117, 129, 150, 153 and 177; C.I. Pigment Green 8; perinone pigments: C.I. Pigment Orange 43; C.I. Pigment Red 194; perylene pigments: C L Pigment Black 31 and 32; I C.I. Pigment Red 123, 149, 178, 179, 190 and 224; C.I. Pigment Violet 29; phthalocyanine pigments: C.I. Pigment Blue 15, 15:1, 15:2, 15:3, 15:4, 15:6 and 16; C.I. Pigment Green 7 and 36; pyranthrone pigments: C.I. Pigment Orange 51; C.I. Pigment Red 216; pyrazoloquinazolone; pigments: C.I. Pigment Orange 67; C.I. Pigment Red 251; thioindigo pigments: C.I. Pigment Red 88 and 181; C.I. Pigment Violet 38; trialylcarbonium; pigments: C.I. Pigment Blue 1, 61 and 62; C.I. Pigment Green 1; C.I. Pigment Red 81, 81:1 and 169; C.I. Pigment Violet 1, 2, 3 and 27; C.I. Pigment Black 1 (aniline black); C.I. Pigment Yellow 101 (aldazine yellow); C.I. Pigment Brown 22. Examples of suitable inorganic color pigments are: white pigments: titanium dioxide (C.I. Pigment White 6), zinc white, pigment grade zinc oxide; zinc sulfide, lithopone; black pigments: iron oxide black (C.I. Pigment Black 11), iron manganese black, spinel black (C.I. Pigment Black 27); carbon black (C.I. Pigment Black 7); chromatic pigments: chromium oxide, chromium oxide hydrate green; chrome green (C.I. Pigment Green 48); cobalt green (C.I. Pigment Green 50); ultramarine green; cobalt blue (C.I. Pigment Blue 28 and 36; C.I. Pigment Blue 72); ultramarine blue; manganese blue; ultramarine violet; cobalt violet; manganese violet; red iron oxide (C.I. Pigment Red 101); cadmium sulfoselenide (C.I. Pigment Red 108); cerium sulfide (C.I. Pigment Red 265); molybdate red (C.I. Pigment Red 104); ultramarine red; brown iron oxide (C.I. Pigment Brown 6 and 7), mixed brown, spinel phases and corundum phases (C.I. Pigment Brown 29, 31, 33, 34, 35, 37, 39 and 40), chromium titanium yellow (C.I. Pigment Brown 24), chrome orange; cerium sulfide (C.I. Pigment Orange 75); yellow iron oxide (C.I. Pigment Yellow 42); nickel titanium yellow (C.I. Pigment Yellow 53; C.I. Pigment Yellow 157, 158, 159, 160, 161, 162, 163, 164 and 189); chromium titanium yellow; spinel phases (C.I. Pigment Yellow 119); cadmium sulfide and cadmium zinc sulfide (C.I. Pigment Yellow 37 and 35); chrome yellow (C.I. Pigment Yellow 34); bismuth vanadate (C.I. Pigment Yellow 184). Examples of inorganic pigments typically used as fillers are transparent silicon dioxide, ground quartz, aluminum oxide, aluminum hydroxide, zinc sulfide, natural micas, natural and precipitated chalk and barium sulfate. Luster pigments are platelet-shaped pigments having a monophasic or polyphasic construction whose color play is marked by the interplay of interference, reflection and absorption phenomena. Examples are aluminum platelets and aluminum, iron oxide and mica platelets bearing one or more coats, especially of metal oxides.

In addition, the particulate tinters can have at least one nonionic surface-active additive based on polyethers such as unmixed polyalkylene oxides, like polyethylene oxides and polypropylene oxides, or alkylene oxide block copolymers. Also, copolymers comprising polypropylene oxide and polyethylene oxide blocks are suitable. They, like the unmixed polyalkylene oxides, can be obtained by polyaddition of these alkylene oxides to saturated or unsaturated aliphatic and aromatic alcohols and aliphatic amines, in which case these starter compounds are reacted with ethylene oxide first and then with propylene oxide, or with propylene oxide first and then with ethylene oxide.

Suitable aliphatic alcohols generally contain from about 6 to about 26 carbon atoms, and may contain from about 8 to about 18 carbon atoms. Examples are octanol, nonanol, decanol, isodecanol, undecanol, dodecanol, 2-butyloctanol, tridecanol, isotridecanol, tetradecanol, pentadecanol, hexadecanol, 2-hexyldecanol, heptadecanol, octadecanol, 2-heptylundecanol, 2-octyldecanol, 2-nonyltridecanol, 2-decyltetradecanol, oleyl alcohol and 9-octadecenol and also mixtures of these alcohols such as C₁₃/C₁₅ and C₁₆/C₁₈ alcohols. Fatty alcohols obtained from natural raw materials by fat hydrolysis and reduction, and the synthetic fatty alcohols from the oxo process are also suitable. The alkylene oxide adducts with these alcohols typically have average molecular weights Mn (number average molecular weight) of from about 400 to about 2,000.

Useful aromatic alcohols, besides .alpha.- and .beta.-naphthol and C₁-C₄-alkyl derivatives thereof include phenol and its C₁-C₁₂-alkyl derivatives, such as hexylphenol, heptylphenol, octylphenol, nonylphenol, isononylphenol, undecylphenol, dodecylphenol, di- and tributylphenol and dinonylphenol. Useful aliphatic amines correspond to the above-recited aliphatic alcohols and the alkylene oxide adducts with these monofunctional amines and alcohols and the alkylene oxide adducts with at least bifunctional amines and alcohols. The at least bifunctional amines may have from two to five amine groups and conform to the formula H₂N—(R—NR₁)ₙ—H(R: C₂-C₆-alkylene; R¹: hydrogen or C₁-C₆-alkyl; n: 1 to 5). Examples include: ethylenediamine, diethylenetriamine, triethylenetetramine, tetraethylenepentamine, 1,3-propylenediamine, dipropylenetriamine, 3-amino-1-ethyleneaminopropane, hexamethylenediamine, dihexamethylenetriamine, 1,6-bis(3-aminopropylamino)hexane and N-methyldipropylenetriamine. These amines can be reacted first with propylene oxide and then with ethylene oxide. The ethylene oxide content of the block copolymers is typically about 10-90% by weight. The block copolymers based on polyamines generally have average molecular weights Mn from about 1,000 to about 40,000 or from about 1,500 to about 30,000.

The at least bifunctional alcohols may have from two to five hydroxyl groups. Examples are C₂-C₈-alkylene glycols and the corresponding di- and polyalkylene glycols, such as ethylene glycol, 1,2-propylene glycol, 1,3-propylene glycol, 1,2-butylene glycol, 1,4-butylene glycol, 1,6-hexylene glycol, dipropylene glycol and polyethylene glycol, glycerol and pentaerythritol.

Suitable alkylene oxide adducts with at least bifunctional alcohols may have a central polypropylene oxide block, being based on a propylene glycol or polypropylene glycol which is initially reacted with further propylene oxide and then with ethylene oxide. The ethylene oxide content of the block copolymers is typically in the range from about 10 to 90% by weight.

The block copolymers based on polyhydric alcohols generally may have average molecular weights Mn from about 1,000 to about 20,000 or from about 1,000 to about 15,000. Such alkylene oxide block copolymers are known and commercially available, for example under the names Tetronic® and Pluronice® (BASF). Alkylene oxide block copolymers (B) are selected with different hydrophilic-lipophilic balance (HLB) values, depending on the application medium in which the pigment granules are to be used. For use in aqueous, aqueous/alcoholic and alcoholic systems, alkylene oxide block copolymers (B) having HLB values of ≧about 10 are suitable, which corresponds to an ethylene oxide content of the copolymers of generally ≧about 25% by weight.

The particulate tinters may include from about 60 to 90% by weight or from 70 to 85% by weight of component (A) and from about 10 to about 40% by weight or from about 10 to about 30% by weight of component (B). They are obtainable by wet-comminuting the pigment (A) in aqueous suspension in the presence of some or all of the nonionic additive (B) and then spray granulating the suspension, if applicable, after the rest of additive (B) has been added Pigment (A) can be used as a dry powder or in the form of a presscake, Pigment (A) may be a finished product, i.e., the primary particle size of the pigment may have already been adjusted to the desired application value. In the case of inorganic pigments, for example in the case of oxide and bismuth vanadate pigments, the primary particle size may also be adjusted in the course of the synthesis of the pigment, so that the as-synthesized pigment suspensions can be used direct. Since the finished pigment (A) typically reagglomerates in the course of drying or on the filter assembly, it is subjected to wet comminution, for example, grinding in a stirred media mill, in aqueous suspension. The wet comminution may be performed in the presence of at least a portion of the additive (B) for the ready-produced particulate tinters, and the entire amount of additive (B) may be added prior to the wet comminution.

Spray granulation is suitably performed in a spray tower using a one-material nozzle. Here, the suspension is sprayed in the form of relatively large drops, and the water evaporates. Additive (B) melts at the drying temperatures and so leads to the formation of a substantially spherical granule having a smooth surface. The gas inlet temperature in the spray tower is generally in the range from 150° C. to 300° C. inclusive or in the range from 180° C. to 300° C. The gas outlet temperature is generally in the range from 70° C. to 150° C. or in the range from 70° C. to 130° C. The residual moisture content of the granular pigment obtained is generally <2% by weight.

The particulate tinters are notable in use for their color properties, which are comparable to those of liquid pigment formulations, especially with regard to color strength, brilliance, hue and hiding power, and especially for their stir-in characteristics, i.e., they can be dispersed in application media with a minimal input of energy, simply by stirring or shaking.

The particulate tinters may have good attrition resistance, a minimal tendency to compact or clump, uniform particle size distribution, good pourability, flowability and meterability, and also dustlessness in handling and application.

Another example of a suitable pigment for the tinter includes a dry pigment blend, comprising the steps of providing at least two pigments, providing a liquid carrier, mixing the two pigments and the liquid carrier to form a liquid pigment mixture, and drying the liquid pigment mixture to form a dry pigment blend. By mixing the pigments in the liquid state, and then drying them, it is possible to produce a dry pigment blend which can be added to a base paint to produce a colored coating composition. By appropriate selection of a mixture of single pigments, it is possible to create a wider range of colors than if only a single pigment is used.

Suitable single pigments for the tinters are those available from S.A. Color or those available from Clariant of 38 Old Road, Duclair LP 116, 76380 Canteleu, France under the trade designation of Effercol for a dustfree and autosoluble dye. Other examples are the pigment dyes for dispersion dyeing from aqueous media such as Cosmenyl dyes available from Clariant, 500 Washington Street, Coventry, R.I., USA as well as pigments available from Elementis, Dugussa or Merck GmbH and combinations of any of these.

By mixing the pigments in the liquid state, a homogenous mix of the individual pigments is established, which gives the dry pigment blend the appearance of being both uniform in color, and indicative of the color hue of the colored coating composition. Furthermore, the fact that a homogenous mix of the pigments is established means that the size of the dry pigment blend particles is not critical in giving the appearance of being uniform in color, and thus it is possible to avoid the hazards associated with fine particles. This contrasts to the dry grinding of individual pigments where the particles need to be ground below a certain size to give a uniform color appearance. The issue of particle size is of particular concern since the mixing of the dry pigment blends with the base paint can take place at the home of the consumer.

The method of producing a dry pigment blend involves firstly selecting an appropriate number and quantity of pigments required to produce a paint of the desired color. Typically, about eight to sixteen pigments may be used to produce a significant color range, although frequently three or four may be used for a particular color.

The particulate dry tinters may be made in a variety of ways. For example, the pigment or pigments can be dry ground with any additives as mentioned above to produce the tinter. Alternative, the pigment or pigments and any other additives as mentioned above can be dissolved, dispersed or suspended in a liquid carrier and mixed together. Once mixed homogeneously, the mixture can be dried by conventional means, for example by oven or splay drying. Where a volatile organic solvent is used in the preparation of the particulate dry tinter, the drying process may be carried out at a temperature and for a time such that the solvent level is reduced to below 10% wt, and may be reduced to below 5% wt, or below 2% wt, or it may be reduced to 0 wt %; that is, the tinter may be free of volatile organic solvents.

Where the mixture is oven dried, the product may be produced as a cake which may require grinding to produce a particulate tinter. The drying temperature and time required for any particular tinter can be determined by routine experimentation.

Similarly, where the mixture is spray dried, the conditions for any particular mixture can again be determined by routine experimentation.

One group of such tinters is disclosed in International Patent Application WO/2007/019950, which is incorporated herein by reference in its entirety. Another group of such tinters is commercially available from BASF under the trade name XFAST.

The tinters of International Patent Application WO/2007/019950, which is incorporated herein by reference in its entirety, comprise at least two colored pigments and the tinter has a color predictive of the color of the tinted coating composition and of the coating composition when applied. The tinters described there are particulate and have an average aggregate particle size in the range of 80 to 400 μm inclusive.

Suitable pigments may include: Mono azo pigments, for example C.I. Pigment Red 112, C.I. Pigment Yellow 74, and C.I. Pigment Orange 67; Iron oxide pigments, for example C.I. Pigment Red 101 and C.I. Pigment Yellow 42; Phtalocyanine pigments, for example C.I. Pigment Blue 15:3, C.I. Pigment Blue 15:4 and C.I. Pigment Green 7; Dioxazine pigments, for example C.I. Pigment Violet 23; Quinacridone pigments, for example C.I. Pigment Red 122; Diketo-pyrrolo-pyrrole pigments, for example C.I. Pigment Red 255; Quinophtalone pigments, for example C.I. Pigment Yellow 138; Black pigments, for example Carbon black C.I. Pigment Black 6 and Furnace carbon black C.I. Pigment Black 7 and White pigment, for example C.I. Pigment White 5 Tinanium Dioxide. Such pigments are commercially available, for example, from BASF, Clariant, Ciba, Degussa, Elementis and Rockwood.

These tinters may contain a filler pigment, that is a substance which has pigment-like properties but has little or no affect on hue, although it will reduce the chroma (that is the intensity) of the hue. They tend to improve the incorporation of the tinters into the base paint. Examples of filler pigments are calcium carbonate, aluminium silicate and clays, including kaolin and china clay.

The tinters may also comprise a dispersing agent. The dispersing agent can be a non-ionic or anionic surfactant or a mixture of the two. It can also comprise a small amount of an auxiliary surfactant. Such surfactants are known.

Examples of non-ionic surfactants include alkyl glucosides, polyglucosides esters, cyclic ether esters, alcohol ethoxylates and fatty acid amide ethoxylates.

Examples of alkylglucosides are C₆-C₁₂ alkylglucosides, for example decyl polyglucoside. Examples of cyclic ethers are sorbitan esters, for example the Tween and Span range of surfactants. Examples of alcohol ethoxylates include C₈-C₁₆ alkyl ethoxylates, including dodecyl ethoxylate.

The fatty acid component of the fatty acid amide ethoxylates can be derived from hexanoic, octanoic, decanoic, dodecanoic, tetradecanoic (or myristic) hexadecanoic (or palmitic) or octadecanoic (or stearic) acid. The acid may also be a mixture of fatty acids as, for example, coco fatty acid, which is a mixture of C₈-C₁₈ fatty acids derived from natural sources. The fatty acid component can also be mono- or di-unsaturated as for example in oleic or linoelic acids.

The ethoxylate component can contain from 1-12 and particularly 4 ethoxylate groups. The molecular weight of such ethoxylated fatty amides can lie in the range from 200 to 1000 inclusive. Example of minima for the molecular weight range are 250, 275 and 300. Examples of maxima for the molecular weight range are 600, 700, 750, 800, 850 and 900, The range may also be from 320 to 820 inclusive.

The dispersing agents referred to above are commercially available from Akzo Nobel.

The proportion of dispersant used in the tinter compositions depends upon the dispersant or dispersant combination employed and the particular pigment, that is the colored pigments and filler pigments. The precise amount in any particular case can be determined by routine experimentation. As a general rule, the total dispersant may be ≦about 20 wt % of tinter and ≧about 5 wt %. For example, the upper limit may be 15 wt % and the lower limit 10 wt %.

Where the dispersant is a mixture, the larger component is the non-ionic dispersant which can be present in an amount from about 1.0-15 wt % inclusive. The anionic dispersant may be present in an amount from about 0.1-5 wt %, but, in some embodiments, may not exceed the amount of non-ionic surfactant.

For example, where the non-ionic dispersant is an alkylglucoside, polyglucoside or fatty acid ethoxylate, it may be present in an amount up to about 15 wt % of the tinter. In practice, the non-ionic dispersant will often be a mixture. In some embodiments, the alkylglucoside may be the major component, being from about 7 wt % to about 10 wt % of the tinter. The balance of the tinter may be made up of either fatty acid amide, or alcohol ethoxylate, or a mixture. In some embodiments, the ethoxylate will not exceed 5 wt % of the tinter.

Where the anionic surfactant is an ethoxylated phosphated alcohol, it typically does not exceed 2.0 wt % Examples of minima in both cases may be 0.1 and 0.2 wt %. Examples of maxima may be 1.0, 1.1, 1.2, 1.5 and 2.0 wt %. Similarly, where an awaiting surfactant, for example, soy bean lecithin, is present, that, too, typically will not exceed 2 wt %.

These tinter compositions may also comprise additives commonly used in liquid tinters, for example, preservatives, defoamers, and humectants.

Examples of preservatives include biocides, in particular Bronopol/(CIT/MIT). Examples of defoamers are polysiloxanes. The amount of optional components to be used in a particular formulation can be determined by routine experimentation. Preservatives and defoamers are generally present in small amounts, e.g., from about 05-2.0 wt % inclusive. Humectants can be used up to, for example, 5 wt %. These additives are commercially available.

The tinters are made by a process which comprises mixing at least two color pigments, a dispersant, and optionally a filler pigment in the presence of a liquid carrier to form an homogenous tinter dispersion mixture and thereafter drying the tinter dispersion to form particles as described in WO2007/019950, which is incorporated herein by reference in its entirety.

Examples of XFAST tinters are 0022 white Rutile titianium dioxide, 1256 yellow arylide yellow, 1990 yellow iron oxide, 3390 red iron oxide, 3855 red Naphthol AS red, 4790 magenta quinacridone, 7080 blue copper phthalocyanine beta, and 8730 Copper Phthalocyanine.

Water soluble films for use as the envelope may be stable to the particulate tinter that they contain and yet soluble in a waterborne paint at ambient temperatures.

A wide variety of polymer films can be used to make these envelopes Examples of such films include: (1) water-soluble films coated internally with wax or other materials which prevent the contents of the envelope contacting the film: see U.S. Pat. No. 3,322,674, which is incorporated herein by reference in its entirety; (2) films made of plasticized polyvinyl alcohol compositions: see U.S. Pat. No. 3,413,229, which is incorporated herein by reference in its entirety; (3) cold water soluble films that comprises a combination of polymers having different molecular weights with the lowest molecular weight polymer of about 21,000: see U.S. Pat. No. 3,892,905, which is incorporated herein by reference in its entirety; (4) films of low molecular weight polyvinyl alcohol compositions and a medium molecular weight polyvinyl acetate, where the “low” and “medium” molecular weights are defined in terms of the viscosity of a solution containing the polymer as shown: see U.S. Pat. No. 4,119,604, which is incorporated herein by reference in its entirety; (5) cold water-soluble polyvinyl alcohol and polyvinyl pyrrolidone films in packaging: see U.S. Pat. No. 4,481,326, which is incorporated herein by reference in its entirety, where the film comprises hydrolyzed polyvinylacetate alcohol and polyvinyl pyrrolidone; water-soluble film composed of polyvinyl alcohol, polyvinyl pyrrolidone, ethoxylated alkyphenol, and polyhydric alcohol that reportedly dissolves in water as cold as 5° C.: see U.S. Pat. No. 4,544,693, which is incorporated herein by reference in its entirety; (6) cold water-soluble films comprising polyvinyl alcohol/polyacrylic acid: see U.S. Pat. No. 4,692,494, which is incorporated herein by reference in its entirety; (7) water-soluble laminate films comprising at least one methylcellulose layer of hydroxybutyl methylcellulose (HBMC) blended with hydroxypropyl methylcellulose (HPMC) and at least one layer of polyvinyl alcohol incorporating a cross-linking agent, whose solubility is pH rather than temperature dependent: see U.S. Pat. No. 4,765,916, which is incorporated herein by reference in its entirety.

Films that dissolve rapidly (that is, in less than 15 minutes, or, in some embodiments, in less than 7 minutes or less than 3 minutes from the dosage unit being added to the base paint) at ambient temperatures (that is, between 0° C. and 40° C.) can include one or more water soluble polymer materials, including, for example, polyvinyl alcohol with a principal solvent, typically diol(s) or derivatives of diols. Other water-soluble polymer films and mixed polymer films include vinyl polymers, including homopolymers and copolymers, having substituents such as hydroxyl and carboxyl, which render them water-soluble. Typical water-soluble polymers include at least one of polyvinyl alcohol, partially hydrolyzed polyvinyl acetate, polyvinyl pyrrolidone, alkyl celluloses for example methylcellulose, ethylcellulose, propylcellulose and derivatives thereof, including ethers and esters of alkyl celluloses, and acrylic polymers, such as water-soluble polyacrylates, polyacrylamides and acrylic maleic Hydride copolymers. Suitable water-soluble polymers further include copolymers of hydrolyzed vinyl alcohol and a nonhydrolyzable anionic comonomer as described in U.S. Pat. No. 4,747,966, which is incorporated herein by reference in its entirety.

In addition, Japanese Published Patent Applications JP 01317506A and JP 60061504A, each of which is incorporated herein by reference in its entirety, describe water-soluble films of polyvinyl alcohol, polyvinyl pyrrolidone, methylcellulose, cellulose acetate, polyethylene oxide, gelatin, partially saponified polyvinyl alcohol, carboxymethylcellulose, dextrin, starch, hydroxyethyl cellulose, agar, pectin and others for the packaging of process chemicals such as sodium sulphate and solid agricultural chemicals. Similarly, British Patent 2,191,379, which is incorporated herein by reference in its entirety, describes the packaging of animal feed supplements in a plastic film of polyvinyl alcohol, polyvinyl acetate, ethylene/vinyl acetate copolymer or an alkylcellulose ester.

Suitable polymer films may be formed from polyvinyl alcohol, vinyl alcohol/vinyl acetate copolymers, polyvinyl pyrrolidone, gelatin, and mixtures of any of the foregoing. Polymer films comprising polyvinyl alcohol can be prepared that are rapidly dissolvable even at colder temperatures, i.e., less than about 10° C. or less than about 4° C. can be used. Further, polyvinyl alcohols having varying average molecular weights (i.e., mean weights of the molar masses) such as from about 6,000 to about 78,000 or higher may be used. Likewise, polyvinyl alcohol having varying degrees of hydrolysis may also be used. Suitably, such polymers can be less than about 90%, less than about 85%, or less than about 80% hydrolyzed, but may be more than about 60%, or in some embodiments, more than at least about 70% hydrolyzed. Blends of water-soluble polymers having different degrees of hydrolysis may also be used. Other suitable polymer films include polyethylene oxide, polyvinyl pyrrolidone, hydroxypropyl methylcellulose and hydroxyethylcellulose.

Blends of water-soluble polymers may also be used Blends are useful in that rapidly dissolving films can be produced with good mechanical properties for subsequent handling and converting into manufactured articles. For instance, a blend containing at least two types of water-soluble polymers that have disparate molecular weights can be used to prepare film that is rapidly dissolving, even under cold water conditions. For instance, such blends can contain at least one type of polymer that has a molecular weight greater than about 50,000, greater than about 60,000, or greater than about 70,000, and a second polymer or mixture of polymers having an average molecular weight of less than about 30,000, less than about 15,000, or less than about 10,000.

In addition, blends of different types of polymer materials can also be formulated and prepared to produce the films. For instance, ratios such as 80/20, 60/40 and 50/50 with mixes of polyvinyl alcohol and polyvinyl pyrrolidone, polyvinyl alcohol and polyethylene oxide, polyvinyl alcohol and hydroxyethyl cellulose, polyvinyl pyrrolidone and hydroxyethyl cellulose, polyvinyl pyrrolidone and polyethylene oxide, and polyethylene oxide and hydroxyethyl cellulose, hydroxypropyl methylcellulose and polyvinyl alcohol, can be used.

A blend can be used of at least one polyvinyl alcohol having a molecular weight of about 78,000 and higher and a second polyvinyl alcohol about 6,000 or lower to achieve a rapidly dissolving film under cold water conditions. Adequate strength of the film for enveloping at least one pigment can be from a low percentage of a higher molecular weight polyvinyl alcohol, around, less than about 50%, less than about 40%, or less than about 30%. A higher percentage of higher molecular weight polyvinyl alcohol, namely, greater than about 50%, greater than about 60%, greater than about 70%, can provide the improved strength and elasticity that is desired for vacuum forming operations, but it should be noted that such higher percentages of high molecular weight polymers are typically accompanied by increasingly higher dissolution times. Blends of high and low molecular weight polymers at ratios of 80/20, 60/40, and 50/50 mixtures of low to high molecular weight polyvinyl alcohol can be evaluated for specific applications.

Also, a rapidly dissolving film can be prepared from a blend of polyvinyl alcohol that comprises from about 60% to about 95% of polyvinyl alcohol of an average molecular weight from about 3,000 to about 30,000 and from about 5% to about 40% of polyvinyl alcohol of an average molecular weight from about 30,000 to about 200,000. The degree of hydrolysis in the polyvinyl alcohol blend is less than about 90 mol %, less than about 85 mol %, or less than about 80 mol %. The film formed from aforementioned compositions can be used with or without a major solvent.

The film compositions can also comprise less than about 50%, such as from about 5% to about 35%, from about 8% to about 25%, or from about 10% to about 20%, of a predominant solvent, by weight of the composition. The principal solvent can be selected to minimize the time required for the water-soluble film to disintegrate and dissolve under cold water conditions.

Dissolution data on films with and without a principal solvent can be obtained from standard solubility test methods. Examples of suitable principal solvents include alcohols, including polyols such as diols. Examples of suitable principal solvents include 1,4-butanediol, 1,3-butanediol and 1,2-hexanediol, 2,2,4-trimethylpentanediol, ethoxylates of 2,2,4-trimethylpentanediol, 2-ethyl 1,3-hexanediol, and 1,4-cyclohexanedimethanol, and 1,2-cyclohexanedimethanol. For molecules exhibiting isomerism, both the trans and cis forms can function as principal solvents. Additional examples of suitable solvents can also include low molecular weight alcohols, polyols, alcohol ethoxylates and the like. In addition, hydrotropes such as sodium toluene sulphonate, sodium butyrate, sodium cumene sulphonate, sodium xylene sulphonate, and other hydrotropic materials can also be used to improve the cold water solubility of the film composition.

Optionally, the film compositions may contain a variety of adjunct ingredients that are well known to those in the film art. Each of these components can be varied according to the levels desired in a given cold water soluble film.

Another example of a suitable water soluble polymeric material are pyrodextrins which are substantially 100% soluble in water, and substantially hydratable in a solution which has low free water, at ambient temperature, have high viscosities relative to a canary dexrin and are solution stable. These dextrins may be prepared by acidifying the starch, and dextrinizing under substantially anhydrous conditions for a time and at a temperature sufficient to result in the desired end product as described in U.S. Pat. No. 6,191,116, which is incorporated herein by reference in its entirety.

Other suitable water soluble polymers include pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein and various mixtures thereof.

The film may be made by known processes. For example, the starch may be dispersed with other film components in water or other solvent and dried to form a film or the starch and other dry components may be blended and then dispersed with any additional film components in water or other solvent and dried to form a film. Films may be formed from such dispersions or solutions by shaping them into a solidified form of a suitable thickness by any technique known in the art including, but not limited to, wet casting, freeze-drying, and extrusion molding.

A suitable process for preparing the films includes preparing a coating formulation by making a solution or dispersion of the film components, applying the mixture to a substrate using knife, bar or extrusion die coating methods, drying the coated substrate to remove the majority of the solvent and removing the film from the substrate Suitable substrates include silicone elastomers, metal foils and metalized polyfoils, composite foils or films containing polyetrafluoroethylene materials or equivalents thereof polyether block amide copolymers, polyurethanes, polyvinylidene chloride, nylon, polyethylene, polyester and other such materials useful in the art as releasable substrates.

The film is not completely dried in that some degree of water or other solvent remains. The amount of water may be controlled to obtain desired functionality. For example, more water typically results in a more flexible film, while too much water results in a film that will block and be tacky.

The film thickness may typically be in the range of about 0.5 to about 5 mils or 1 to 500 μm, particularly 25 to 100 μm especially if the film has an embossed pattern on imprinted on it giving areas of decreased thickness. For a suitable film thickness to form a layer of a pouch for hand mixing into latex paint for quick dissolution without visual appearance of any undissolved remnants, the film thickness is more preferably from about 25 to 50 μm, Thicker films may be used in higher viscosity coating compositions or the like.

The films can be wetted when exposed to water, such as when placed in a water borne paint or other substrate surface, followed by rapid dissolution, disintegration, or both. The wettability and dissolution rates of the starches may be modified by one skilled in the art to target a specific delivery profile.

Suitable water soluble polymeric films include those specialty water soluble polyvinyl alcohol based films, such as, for example, M-3030, available from MonoSol LLC, of Indiana, which can be used even with slightly alkaline coating compositions. Such a film at a thickness in the range of 0.5 to 3 mils can handle premeasured unit doses of water dispersible particulate tinters. If one or both major opposing surfaces of the film are embossed to give the film thinner portions the general average thickness of the film can be slightly thicker, even to 5 mils.

Such films encapsulating the particulate tinters offer a multitude of benefits in providing the end-user with pre-packaged, pre-measured unit doses for coloring paints where the risk of direct contact with the pigments has been reduced. The M-3030 film is available from MonoSol in thicknesses ranging from 1 to 2.0 mil and in widths up to 137 cms.

The envelope can be in the form of a pouch, packet sachet or similar structure. The water soluble films referred to above can be formed into pouches or packets by placing two sheets of film in registry opposite each other and heat sealing around the perimeter of at least three sides to form a pocket or pouch into which the tinter be placed and the final side then sealed.

The size of the envelope is chosen bearing in mind the volume of the paint to be tinted and ease of handling on the part of the user who would be tinting the base paint. Tinters, even dry particulate tinters, are normally dispensed by volume. So the size of the envelope is typically sufficient to accommodate the maximum volume of tinter In one embodiment, the envelope may be of a size sufficient to accommodate up to 400 ml of tinter. In another embodiment, the envelope would not be smaller than that necessary to accommodate 5 ml of tinter. So, for example, the envelope may have a volume of, for example, 100 to 400 ml inclusive, or 50 to 100 ml inclusive, or 20 to 50 ml inclusive or 10 to 20 ml inclusive or 5 to 10 ml inclusive.

When the films listed above are formed into packets, pouches, sachets or the like they may have a seam where two or more layers or pieces of film are joined. If the seam, which would be around double the thickness of the thickness of the film, is outside the range of thickness for the film the seam can be embossed to reduce portions of its thickness to assist in dissolving the pouch. Such pouches can be filled with granular materials by known methods.

The filling of the tinting material into the envelope can be carried out in a horizontal form/fill/seal apparatus, individual envelopes can be formed by folding the polymeric film in half followed by providing vertical seals along the length of the folded sheet and separating the envelopes along the seals formed by vertical sealing. Optionally, the bottoms of the envelopes can also be sealed. After the envelope is formed and filled, the top is sealed Similarly, in vertical form/fill/seal apparatus, the continuous sheet can be formed around a tube and the sheet is immediately joined together by a longitudinal sealing jaw as either a lap seal or a fin seal. For additional information regarding such packaging systems, see U.S. Pat. Nos. 4,671,047; 4,807,420; 4,807,420; 4,090,344, and 4,937,112, all of which are hereby incorporated by reference.

A second sealing function may be present in a vertical form/fill/seal configuration which consists of a combination top and bottom sealing section (with a bag cut-off device in between). The top-sealing portion seals the bottom of an empty bag suspended from the bag forming tube while the bottom portion seals the top of a filled bag.

In most processes for packaging products, the package is formed and filled by creating a heat seal between two opposed sheets of polymeric film to form an envelope in the form of a pouch and almost simultaneously sliding or dropping the tinting material into the pouch. In these form and fill packaging techniques a continuous flat sheet of polymeric film is fed around a form which shapes it into a tube, the tube is slipped over a hollow form and the free edges of the tube are sealed together. The tube so formed is then passed between a pair of hot sealing jaws which create a series of discrete pouches by collapsing the film onto itself and forming a seal by the application of heat and pressure. The product is introduced into each pouch through the hollow form in the interval between the heat seals. During high operating speeds, the tinting material can be dropped into the pouch while the sealing jaws, which form the seal, are closed. With both vertical and horizontal form and fill sealing applications the heat seal should be strong enough to support and retain the substance after the sealing jaws open to release the film. It is often desirable to release the sealing jaws soon after the seal is formed so a film which accomplishes this by exhibiting a high “hot tack” is very useful. Hot tack refers to the strength of the heat seal immediately following the sealing operation.

Additionally, in packaging applications there is a great demand for heat sealable films which can be subjected to temperatures high enough to seal the films without causing the substrate to cockle or pucker. One approach for achieving this is by coating a film substrate with a layer of heat sealable material which adheres strongly to the substrate and which can be melted at a temperature below the softening temperature of the substrate. Heat-sealable coatings with low melting temperatures are often preferred because the substrate is less likely to be damaged during heat sealing.

After the pouch is formed, filled and sealed, one or more of the pouches can be filled into a moisture resistant pack that reduces the risk of premature dissolving of the pouch in humid environment prior to use in a tinting scheme, Suitable moisture resistant containers include glass jars with lids and film packages such as those of U.S. Pat. No. 5,419,960, which is incorporated herein by reference in its entirety and discloses a film with a low temperature sealable coating. The coating contains a copolymer of ethylene and acrylic or methacrylic acid. U.S. Pat. Nos. 6,077,602 and 5,843,582, each of which is incorporated herein by reference in its entirety, disclose heat sealable film coatings containing a terpolymer produced from a nitrile monomer, an acrylate or 1,3 butadiene monomer, and an unsaturated carboxylic acid or sulfoethyl methacrylate. U.S. Pat. Nos. 6,013,353 and 5,827,615, each of which is incorporated herein by reference in its entirety, disclose metallized films with heat sealable coatings, on the surface of the metal, containing a copolymer of a carboxylic acid and an acrylate, or acrylonitrile or mixtures thereof.

In the preparation of films useful for packaging purposes having moisture resistant properties, the outside of the film or the side of the film which comes in direct contact with the hot sealer surfaces may have good hot slip and jaw release characteristics. Additionally, the film may have good machinability so that the wrapped product can be conveyed easily through the overwrapping machine without sticking to adjacent packages or the parts of the machine with which it comes into contact, which can cause production delays. Acrylic-containing coatings which offer these properties are known. The acrylic-containing coating is applied to one side of the film substrate and another heat sealable coating, such as polyvinylidene chloride (PVdC), or another acrylic coating, is coated on the other side. Acrylic-containing coating formulations provide the film with a good coefficient of friction, which contributes to good machinability characteristics. These acrylic-based coatings also provide films with good barrier characteristics, which improve flavor and aroma protection. Such coatings are described in U.S. Pat. Nos. 4,058,649 and 4,058,645, each of which is incorporated herein by reference in its entirety.

The PVDC coating or other type of acrylic coating is usually on the inside of the film and provides high seal strength, good hot tack characteristics and barrier properties. These heat sealable coatings have glass transition (“Tg”) temperatures which are higher than room temperature. Such a coated film is disclosed in U.S. Pat. No. 4,403,464, which is incorporated herein by reference in its entirety. Also U.S. Pat. No. 4,456,741, which is incorporated herein by reference in its entirety, discloses heat sealable terpolymer compositions useful as pressure-sensitive adhesives for use with a backing material such as paper, polyester film or, foamed polymers. The terpolymer heat sealable pressure-sensitive adhesive composition comprises butyl acrylate, N-vinyl-2-pyrrolidinone and styrene. Other heat sealable coatings are disclosed in U.S. Pat. No. 3,696,082 and East German Patent DD-146,604, each of which is incorporated herein by reference in its entirety.

The coating may be applied to polymeric substrates having other coatings or overlayers such as a metallized layer. The films with the metallic layer can be filled with the one or more pouches and then heat sealed. In such applications, generally speaking, the faster a package is routed through the filling and sealing process, the more economic the packaging process. Therefore, in some embodiments, the packing film may have a low minimum seal temperature to reduce the process residence time necessary to reach the minimum seal temperature. Of course, it is understood that the minimum seal temperature may not be too low so as to avoid activation of the sealing properties during storage or transit at high atmospheric temperatures. Moreover, the higher the seal strength of the heat seal immediately following the sealing operation, the faster the package may be processed thereafter without risking an unacceptably high seal failure rate. This characteristic, known as “hot tack”, is a measure of the cohesive strength of the heat seal during the cooling stage before solidification of a heat seal. Hot tack is determined by tearing a seal apart to measure the seal strength immediately after the seal is formed and before it cools down. Hot tack is measured in force per unit of seal width. Generally, the higher the hot tack the better since this will promote faster processing and handling of the sealed package.

Suitable laminate layers for the package includes metalized foil paper layer laminated to a cast polypropylene layer and another layer of PET, polyethylene or EVOM. There may be a fourth layer which can be from the cast polypropylene laminate material retains its filled shape even as the product is removed from the pouch so that the pouch can even be shaped like a traditional cylindrical can but more suitably stored in a moisture-proof package including, e.g., sealed metal foil pouches. These are for example of a flexible nature, such as of flexible plastics material or metal foil or laminates of these materials, but they can also be for example be rigid in nature, such as of rigid plastics material or metal or glass.

The pouches provide a system that can deliver not only deeper shades of a monochromatic color, but also can deliver within one pouch, blended tinters to deliver one color. In the method of adding one or more pouches to a base paint even greater flexibility is achieved in making and marketing paints with a variety of colors by paint manufacturers and retailers, who can decide on the size of the system, or the number of colors to be offered, since the system is easy to customize, including by having fewer or greater numbers of bases, to expand or reduce the number of colors offered to account for market size as well as regional preferences, to provide greater versatility in the layout or organization of the colors in the rack and as a result of one or more of the above objectives to provide a cost savings, as compared to previous equipment laden systems.

The pouches may contain tinters formulated for addition to base paints. Suitable base paints may include one or more Pastel Bases—a base containing from 1.7 to 2.5 pounds, or from 2.0 pounds to 2.2 pounds of titanium dioxide and comprising 124-128 fluid ounces; up to 2 ounces of colorant can be added to provide about a gallon (128 ounces) of paint A pastel base without colorant contains sufficient hiding power to be used as a paint due to its titanium dioxide content, A Tint Base—a base containing from 1.5 to 2.0 pounds, or from about 1.5 pounds to 1.68 pounds of titanium dioxide in 122-126 fluid ounces; from two ounces to four ounces of colorant can be added to provide about a gallon of paint A Deep Base—a base containing from 0.5 to 1.0 pounds, or from 0.50 pounds to 0.68 pounds of titanium dioxide in 118-124 fluid ounces; up to eight ounces of colorant can be added to provide about a gallon of paint. An Accent Base—a clear or transparent base consisting of 112-118 fluid ounces containing no titanium dioxide; up to twelve ounces of colorant can be added to provide about a gallon of paint.

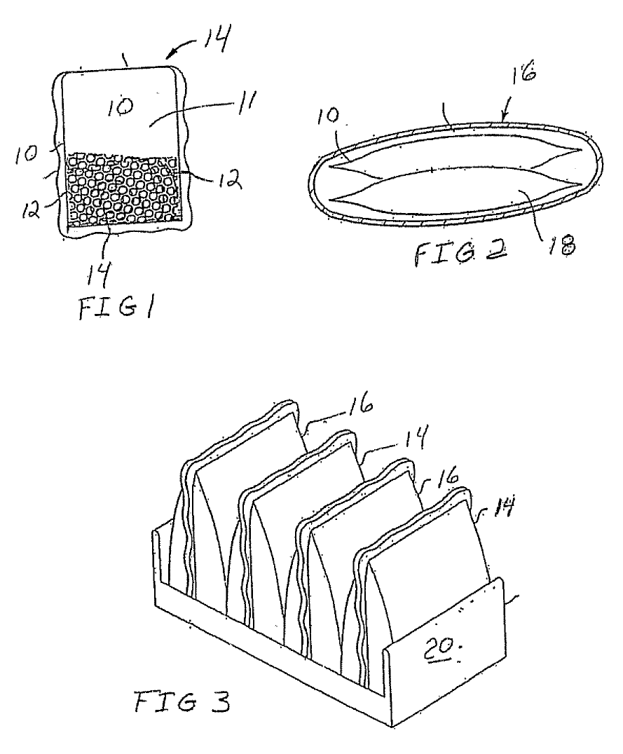

In the drawings. FIG. 1 shows a moisture resistant package 14, which is schematically depicted as surrounding pouch 10. Pouch 10 is shown in a cut away view having the water soluble polymeric layer 11 and cut away section 12 showing the particulate tinting material.

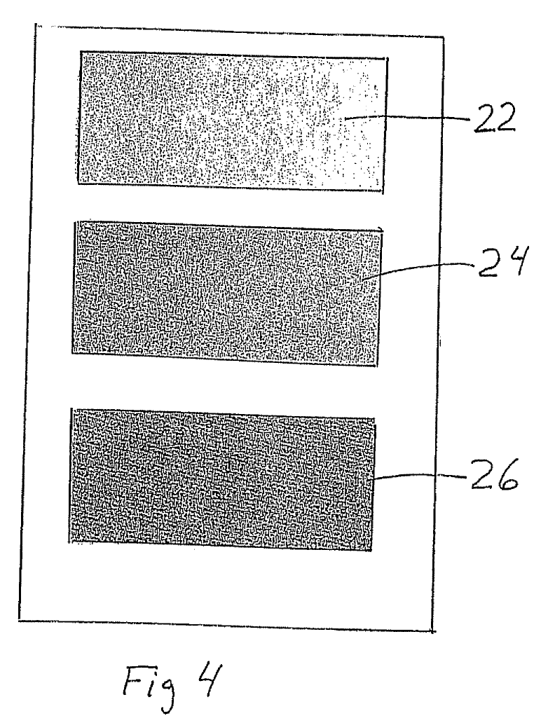

FIG. 2 of the drawings shows a cross-sectional view of a moisture resistant package 16 having the coating composition and effective headspace for agitation and having a plurality of pouches 10 and 18 which can provide different shades or colors.

FIG. 3 shows a kit 20 having a plurality of moisture resistant packages 14 or 16. Kit 20 shows that packages 14 and 16 can be arranged such that one pouch can be present in the package or a plurality of pouches can be present in a package. A moisture resistant package with a plurality of pouches, such as that of FIG. 2 can be used to produce the range of shades of color depicted in FIG. 4. A plurality of three pouches could be present in one moisture resistant package or in three separate moisture resistant packages to produce, for example, a light shade 22, a medium shade 24, or a deeper shade 26. In an exemplary method of adding the pouches to any tint base paint, the pouch for shade 22 can be added first. If the user wants a deeper shade, the pouch for shade 24 can also be added to the same base paint. If still a deeper shade is desired, the third pouch can be added to the same base paint to produce shade 26.

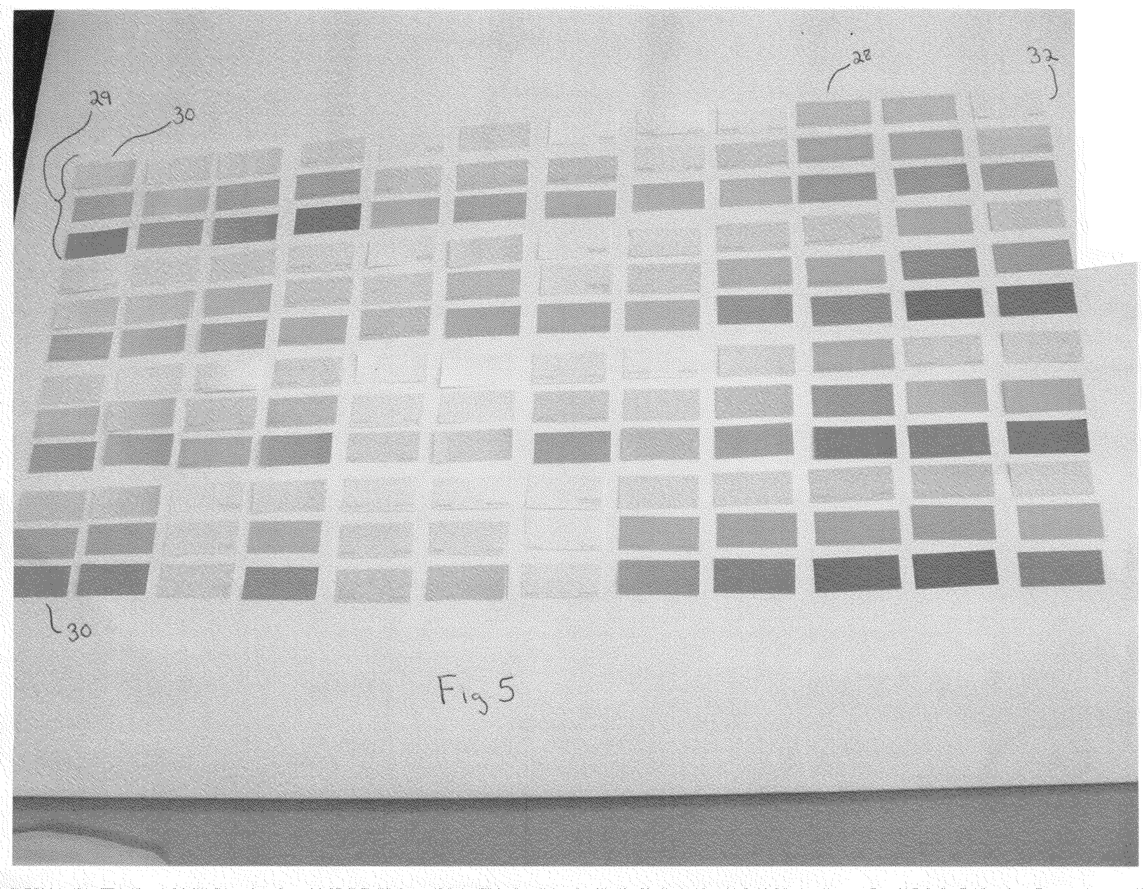

FIG. 5 shows an exemplary range of color in a system of pouches, ranging from colors of column 32 to column 33 and row 32 to row 34. Each pouch would have tinting material to produce the shade as depicted, for instance, at reference 29. The three pouches would be used in a manner similar to that described for FIG. 4. Reference 28 shows the three shades of FIG. 4. So with a system of pouches for addition to a minimum of base paints, a retailer can provide to the user various color schemes for matching colors in other decorating materials such as furniture, draperies, linens and the like.

The base paints include emulsion paints, including water borne matt, eggshell, semi-gloss and gloss paints. Such paints generally comprise a film forming emulsion polymer, titanium dioxide, fillers, dispersants, surfactants and thickeners dispersed in an aqueous vehicle. Examples of film forming emulsion polymers include acrylic, vinyl acrylic and ethylene vinyl acetate polymers, which are commercially available under the trade mark ROVACE from Rohm & Haas and EVOCAR from Dow.

Examples of fillers are clays and diatomaceous earths available under the trade names OPTIWHITE and DIAFIL respectively, and aluminosilicates available as part of the ASP range.

Examples of dispersants are Hydropalat 44 and Tamol 165. Examples of surfactants are Triton and Synperonic. Examples of thickeners are Attagel, Acrysol RM, Natrosol Plus and Lattice.

Base paints formulated from the above ingredients have low to zero volatile organic solvent contents (VOC). Generally speaking, the paints will have a VOC of less than about 100 g/l. An interior eggshell finish will have a VOC content of less than about 40 g/l. An interior matt emulsion will have a VOC content of less than about 30 g/l. The VOC content of paint of any finish type may be less than about 10 g/l, less than about 5, less than about 3, or less than about 2 g/l. Paints of less than about 5 g/l VOC may be regarded as VOC free.

A conventional mixing scheme comprises a collection of tinters sufficient when used singularly or in combination to produce a range of colors, a base paint and optionally a mixing station. The scheme may comprise at least 8 and up to 12 or 16 tinting dosage units. In particular, there may be sufficient dosage units to produce a tinted paint in any one of the colors red, yellow, green, and blue. The tinting dosage units may be available in racks where the colors will be grouped together and displayed generally in the same order as in the spectrum. Neutral colors such as greys, fauns and browns may optionally be displayed separately.

Typically the scheme will comprise one base paint for each finish, matt, egg shell, semi-gloss and gloss. Optionally the base paint can also be provided as a deep base for dark colors and a light base for light colors. The mixing station can be a mechanical shaker or mechanical stirrer into which the container of base paint to which the tinting dosage unit or units has been added can be placed for mixing preferably the mixing machine is a mechanical shaker. The tinters may be mixed into the base paint by hand.

### EXAMPLES

The following examples are provided to illustrate various embodiments and shall not be considered as limiting in scope.

### Example 1

### Preparation of Particulate Dry Tinter

1.1 Water dispersible dry tinters can be prepared as described in WO/2007/019950, which is incorporated by reference herein in its entirety.

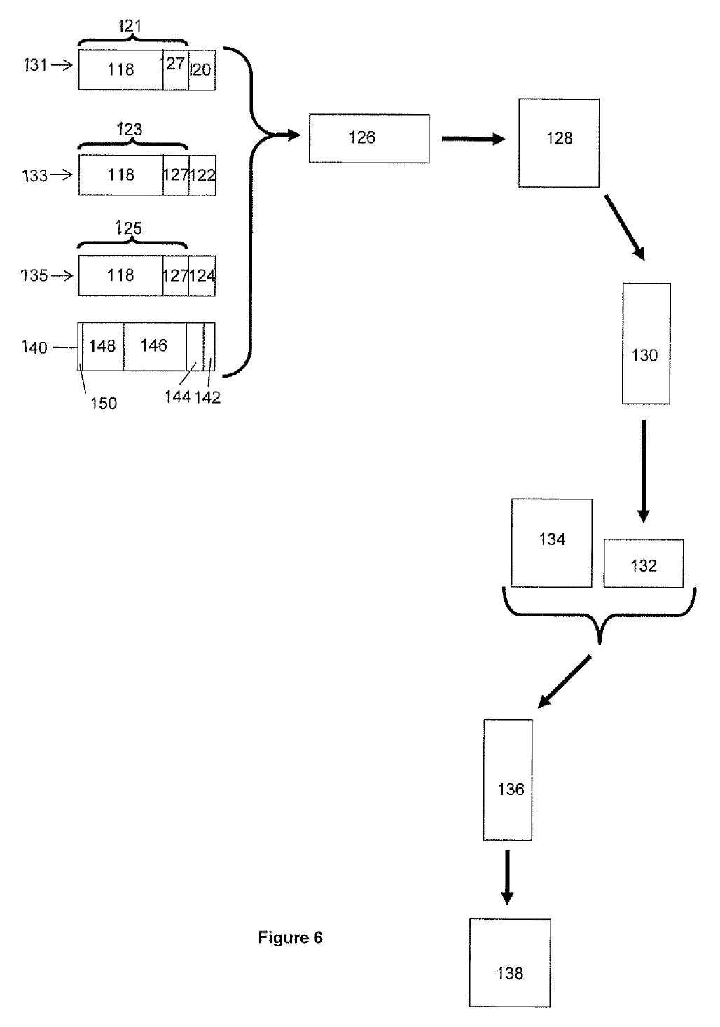

FIG. 6 is a schematic representation of an exemplary process for producing a particulate dry tinter according to the present embodiment.

Referring to FIG. 6, colored pigments 120, 122 and 124 were each dispersed in a liquid carrier 121, 123 and 125 to produce predispersions 131, 133 and 135. The make-up of these dispersions is set out in Tables 1 to 3 respectively. The predispersions 131, 133 and 135 in the proportions set out in Table 5 were mixed together for 20 minutes in a high speed disperser with tinter extender 140. Tinter extender 140 is a mixture of the components set out in Table 4. The mixture was then oven dried at a temperature between 60° C. and 100° C. for 8 hours to produce a cake that was ground to produce granular powder having a mean particle size in the range 100 to 250 μm. This powder tinter contains less than 2% volatile organic solvents.

1.2 A second tinter was prepared as described in Example 11, except that the mixture was dried by spray drying in a conventional spray drier at an inlet temperature of 200° C. to produce a granular; powder having a mean particle size in the range of 100 to 250 μm. This powder tinter contains no volatile organic solvents.

1.3 A third tinter was made according to the process of Example 1.1, substituting the extender tinter of Table 4 with the extender tinter of Table 6. This powder tinter contains less than 2% volatile organic solvents.

TABLE 1

| Pre-dispersion | | Wt % in | Wt % in |
|---|---|---|---|
| 31 Components | Chemical Name | dispersion | tinter |
| Liquid Carrier | Water | 34.7 | 0.00 |
| Humectant | Propylene Glycol | 2.5 | 3.92 |
| Humectant | Polyethylene | 4.2 | 6.59 |
| | Glycol | | |
| Dispersing Agent | Ethoxylated phosphated | 0.96 | 1.52 |
| | alcohol | | |
| Dispersing Agent | Fatty acid ethanolamide | 7.62 | 10.14 |
| Defoamer | Polysiloxane | 0.3 | 0.27 |
| Colored Pigment | Copper phthalocyanine | 44.4 | 69.67 |
| Filler Pigment | Aluminium Silicate | 5.0 | 7.78 |
| Preserving Agent | Bronopol/(CIT/MIT) | 0.3 | 0.10 |

TABLE 2

| Pre-dispersion | | Wt % in | Wt % in |
|---|---|---|---|
| 33 Components | Chemical Name | dispersion | tinter |
| Liquid Carrier | Water | 44.17 | 0.00 |
| Humectant | Glycerol | 2.4 | 0.00 |
| Humectant | Polyethylene Glycol | 4.20 | 7.88 |
| Dispersing Agent | Soya Lecithin | 1.57 | 2.94 |
| Dispersing Agent | Fatty acid ethanolamide | 6.04 | 10.98 |
| Defoamer | Polysiloxane | 0.3 | 0.34 |
| Colored Pigment | Carbon Black | 20.01 | 37.56 |
| Filler Pigment | Aluminium Silicate | 21.01 | 40.11 |
| Preserving Agent | Bronopol/(CIT/MIT) | 0.3 | 0.19 |

TABLE 3

| Pre-dispersion | | Wt % in | Wt % in |
|---|---|---|---|
| 35 Components | Chemical Name | dispersion | tinter |
| Liquid Carrier | Water | 59.08 | 0.00 |
| Humectant | Propylene Glycol | 2.6 | 6.47 |
| Humectant | Polyethylene Glycol | 4.28 | 10.64 |
| Dispersing Agent | Ethoxylated phosphated | 2.66 | 6.61 |
| | alcohol | | |
| Dispersing Agent | Soya Lecithin | 3.69 | 9.18 |
| Dispersing Agent | Fatty acid ethanolamide | 2.79 | 5.55 |
| Defoamer | Defoamer | 0.3 | 0.44 |
| Colored Pigment | Quinacridone | 24.3 | 60.42 |
| Preserving Agent | Bronopol/(CIT/MIT) | 0.3 | 0.69 |

TABLE 4

| Filler Pigment | | | |
|---|---|---|---|
| Pre-dispersion | | Wt % in | Wt % in |
| 40 Components | Chemical Name | dispersion | tinter |
| Liquid Carrier | Water | 30.75 | 0.00 |
| Dispersing Agent | Ethoxylated phosphated | 7.0 | 9.11 |
| | alcohol | | |
| Dispersing Agent | Fatty acid ethanolamide | 4.6 | 4.91 |
| Preserving agent | Bronopol/(CIT/MIT) | 0.1 | 0.04 |
| Filler Pigment | Aluminium Silicate | 57 | 85.45 |
| Defoamer | Polysiloxane | 0.55 | 0.49 |

TABLE 5

| Tinter Dispersion 28 Components | Wt % in dispersion |
|---|---|
| Extender Tinter Pre-dispersion 40 | 85.00 |
| Pre-dispersion 31 | 6.77 |
| Pre-dispersion 33 | 1.50 |
| Pre-dispersion 35 | 6.73 |

TABLE 6

| Filler Pigment | | | |
|---|---|---|---|
| Pre-dispersion | | Wt % in | Wt % in |
| Components | Chemical Name | dispersion | tinter |
| Liquid Carrier | Water | 30.75 | 0.00 |
| Dispersing Agent | Fatty acid | 11.6 | 14.02 |
| | ethanolamide (non- | | |
| | ionic surfactant) | | |
| Preserving agent | Bronopol/(CIT/MIT) | 0.1 | 0.04 |
| Filler Pigment | Aluminium Silicate | 57 | 85.45 |
| Defoamer | Defoamer | 0.55 | 0.49 |

### Example 2

### Preparation of a Base Paint

A flat matt emulsion base paint was prepared by known methods by mixing together the following ingredients listed in Table 7 by standard techniques.

TABLE 7

| Component | WT % |
|---|---|
| Vinyl Acrylic Latex | 21.8 |
| Rutile Titanium dioxide | 19.6 |
| Defoamer | 0.52 |
| Biocide | 0.09 |
| Dispersant | 0.5 |
| Surfactant | 0.26 |
| Thickener | 2.18 |
| Clay | 6.97 |
| Mineral Extender | 11.32 |
| Cellulose Thickener | 0.69 |
| Water | 36.07 |
| Total | 100 |
| VOC g/l USA | 1.23 |

### Example 3

### Preparation of Tinters

3.1 Pink

A pink particulate tinter was made by mixing black tinter (1.13 g) with red iron oxide tinter (0.83 g), magenta tinter (0.7 g) and white tinter (7.45 g). The mixture was then blended until it was homogenous to produce a dry particulate tinter (10.11 g), (10.85 ml) which into a polyvinyl alcohol pouch.

3.2 Orange

An orange particulate tinter was made by mixing together black tinter (13.74 g), yellow tinter (90.1 g) and red tinter (60.9 g). The mixture was blended until it was homogeneous to produce a dry particulate tinter (164.7 g), (341.65 ml) which was filled into a polyvinyl alcohol pouch.

3.3 Yellow

A yellow particulate tinter was made by mixing together black tinter (0.10 g), yellow tinter (19.25 g) and red tinter (0.52 g). The mixture was blended until it was homogeneous to produce a dry particulate tinter (19.87 g), (44.00 ml) which was filled into a polyvinyl alcohol pouch.

In the above examples the red tinter was XFAST 3855, the yellow tinter was XFAST 1256, the red iron oxide tinter was XFAST 3390, the white tinter was XFAST 0022, the magenta tinter was XFAST 4790, the black tinter is an equivalent to XFAST 0066.

3.4 Pouch Filling

The pouches referred to in this example are made from polyvinyl alcohol film made by Monosol LLC of Portage Ind. under the trade name PXP6160. The PVA film is cut to size based on the volume of dry particulate tinter and sealed on three sides using a “Clamco Model 250” thermosealer. The tinter is then poured into the pouch and the forth side sealed.

### Example 4

### Preparation of a Tinted Paint

One U.S. gallon of pink tinted paint was prepared by adding one tinter-containing pouch prepared as described in Example 3.1 to one U.S. gallon of base paint prepared as described in Example 2 and shaking the mixture with a mechanical shaker for 5 minutes to ensure that the paint was homogenous in color. The resultant paint had a volatile organic solvents concentration of less than 2 g/l.

Notwithstanding that the numerical ranges and parameters setting forth the broad scope of the invention are approximations, the numerical values set forth in the specific examples are reported as precisely as possible Any numerical value, however, inherently contains certain errors necessarily resulting from the standard deviation found in their respective testing measurements.

Furthermore, while the systems, methods, and so on have been illustrated by describing examples, and while the examples have been described in considerable detail, it is not the intention of the applicant to restrict, or in any way, limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's general inventive concept.

Thus, this application is intended to embrace alterations, modifications, and variations that fall within the scope of the appended claims. The preceding description is not meant to limit the scope of the invention. Rather, the scope of the invention is to be determined by the appended claims and their equivalents.

Finally, to the extent that the term “includes” or “including” is employed in the detailed description or the claims, it is intended to be inclusive in a manner similar to the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A of B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modem Legal Usage 624 (2d, Ed. 1995).

What is claimed is:

1. A tinting scheme for making low volatile organic solvent-containing waterborne paints, comprising:
a plurality of tinting dosage units, each tinting dosage unit comprising a predetermined quantity of a water dispersible particulate tinter comprising a pigment or mixture of pigments in a water soluble envelope;
one or more base paints whose volatile organic solvents content is less than about 150 g/l;
such that in use the one or more tinting dosage units is added to the one or more base paints to produce a tinted paint whose volatile organic solvents content is less than about 150 g/l.

2. The tinting scheme of claim 1, having at least eight tinting dosage units, each tinting dosage unit having a water dispersible particulate tinter of a different hue.

3. The tinting scheme of claim 1, having sufficient tinting dosage units to produce the tinted paint in any one of the colors red, yellow, green and blue.

4. The tinting scheme of claim 3, wherein the water soluble envelope contains from about 10 to about 500 grams of the water dispersible particulate tinter.

5. The tinting scheme of claim 1, wherein the water soluble envelope comprises one or more of polyvinyl alcohol, vinyl alcohol/vinyl acetate copolymer, polyvinyl pyrrolidone or gelatine film or film made up of a mixture of the foregoing.

6. The tinting scheme of claim 1, wherein the water soluble envelope is in the form of a packet, pouch, or sachet.

7. The tinting scheme of claim 1, wherein the base paint is an emulsion paint.

8. The tinting scheme of claim 7, wherein the base paint has a volatile organic solvent content of less that about 5 g/l

9. A tinting dosage unit for use in a tinting scheme according to claim 1.

10. A paint composition, comprising:
a waterborne base paint having a volatile organic solvents content of less than about 150 g/l;
a water dispersible particulate tinter, the water dispersible particulate tinter being derived from one or more tinting dosage units, each tinting dosage unit comprising a water soluble envelope, wherein the water dispersible particulate tinter comprises one or more pigments, and wherein the water dispersible particulate tinter has a volatile organic solvents content of less than about 5%;
wherein the paint composition has a volatile organic solvents content of less than about 150 g/l.

11. The paint composition of claim 10, wherein the water dispersible particulate tinter is derived from at least one of at least 8 tinting dosage units, the water dispersible particulate tinter of each tinting dosage unit being of a different hue.

12. The paint composition of claim 10, wherein the base paint is an emulsion paint.

13. The paint composition of claim 12, wherein the base paint has a volatile organic solvents content of less that about 5 g/l.

14. A method of tinting a waterborne paint, comprising:
providing one or more tinting dosage units comprising a water dispersible particulate tinter, the water dispersible particulate tinter having a volatile organic solvents content of less than about 5%;
providing one or more base paints having a volatile organic solvents content of less than about 150 g/l; and
mixing the one or more tinting dosage units with the one or more base paints to produce a tinted, waterborne paint having a volatile organic solvents content of less than about 150 g/l.
